(19) United States
(12) Patent Application Publication
(10) Pub. No.: US 2024/0383515 A1
(43) Pub. Date: Nov. 21, 2024

(54) BEEHIVE FRAME TRANSPORT CART

(71) Applicant: A.C.N. 652 266 101 Pty Ltd., Claremont (AU)

(72) Inventor: Jessica Kate Brunner, Claremont (AU)

(73) Assignee: A.C.N. 652 266 101 Pty Ltd., Claremont (AU)

(21) Appl. No.: 18/688,752

(22) PCT Filed: Aug. 25, 2022
(86) PCT No.: PCT/AU2022/051014

§ 371 Date: Mar. 1, 2024

(30) Foreign Application Priority Data
Sep. 2, 2021 (AU) 2021902849

(51) Int. Cl. B62B 1/26; A01K 47/02

(52) U.S. Cl. CPC B62B 1/26; A01K 47/02; B62B 2202/12

(57) ABSTRACT

Provided is a beehive frame transport cart (10) comprising a support frame (12) supporting a wheeled reservoir container (14) which defines a honey reservoir (16) with a tap (18) located at a bottom thereof. Also included is a plurality of open-bottomed frame containers (20) each configured sealingly to stack on the reservoir container (14) and/or each other, each frame container (20) defining an internal upper peripheral ledge (22) for receiving ends of beehive frames to suspend a plurality of said frames in a substantially vertical and side-by-side manner within said frame container (20). Cart (10) also includes a plurality of foraminous queen excluder plates (24) each insertable at a bottom of a stacked frame container (20), and a lid (26) configured to seal an upper stacked frame container (20), or to engage with a bottom of a frame container (20) to form a drip tray, as required, wherein a plurality of beehive frames is receivable, transportable and storable within the cart.

### TECHNICAL FIELD

This invention relates broadly to the field of apiculture, and more particularly to a beehive frame transport cart that finds particular application in the field of beehive inspection, removal and transport of frames from a beehive.

### BACKGROUND ART

The following discussion of the background art is intended to facilitate an understanding of the present invention only. The discussion is not an acknowledgement or admission that any of the material referred to is or was part of the common general knowledge as at the priority date of the application.

Beekeeping (or apiculture) is the maintenance of bee colonies, commonly in man-made hives. Most such bees are honey bees in the genus Apis, but other honey-producing bees such as Melipona stingless bees are also kept. A beekeeper (or apiarist) generally keeps bees in order to collect their honey and other products that the hive produces (including beeswax, propolis, flower pollen, bee pollen, and royal jelly), to pollinate crops, or to produce bees for sale to other beekeepers.

A beehive's internal structure is generally a densely packed group of hexagonal prismatic cells made of beeswax, called a honeycomb. The bees use the cells to store food (honey and pollen) and to house the brood (eggs, larvae, and pupae). Although man have practiced beekeeping since ancient times, the 19th century saw a revolution in beekeeping practice due to the development of the movable comb hive by Lorenzo Lorraine Langstroth. Langstroth was the first person to make practical use of an earlier discovery that there was a specific spatial measurement between wax combs in a beehive, later called the “bee space”, which bees do not block with wax, but keep as a free passage. Having determined this bee space as usually between 5 and 8 mm, Langstroth then designed a series of wooden frames within a rectangular hive box, carefully maintaining the correct space between successive frames, and found that the bees would build parallel honeycombs in the box without bonding them to each other or to the hive walls.

This discovery and subsequent hive design enabled beekeeping where a frame is slidable or removable from a hive for inspection, without harming the bees or the comb. It also meant that combs containing honey could be gently removed and the honey extracted without destroying the comb. The emptied honey combs could then be returned to the bees intact for refilling. The development of the movable-comb-hive fostered the growth of commercial honey production on a large scale.

In general, a conventional Langstroth hive comprises a bottom board at the bottom of the hive with an entrance to the beehive. On top of the bottom board is a deep hive body, i.e. a wooden box with frames of comb where the queen bee lays eggs. This part of the beehive is also called the ‘brood chamber’ or ‘brood box’—where brood rearing takes place, ‘brood’ being the term for bee larva. So-called ‘supers’ are placed on top of the brood chamber. ‘Supers’ are wooden boxes with frames of comb where the bees store honey. A ‘queen excluder’ is typically placed between the brood chamber and the supers. The queen excluder is a grate adapted so that worker bees are small enough to crawl through it but the queen is too big. This keeps the queen from laying eggs in the honey supers. The deep hive body and the supers each contain around ten removable frames of comb, separated by a suitable bee space. On top of the hive, an inner cover and an outer cover are used-the inner cover to keep the hive tightly closed and the outer cover to serve as extra protection against the elements.

One shortcoming with conventional beehives is the proper handling and management of frames during inspection and harvest of honey. In order to safely inspect a beehive for hive management purposes, an apiarist must regularly lift an entire full top Super complete with 8 to 10 frames for access to a lower Super and/or the brood box. This can weigh in excess of 25 kilograms which needs to be placed to the side and then replaced following inspection. Alternatively, frames are removed individually and placed on the ground or suspended off hangers which exposes bees to external elements and risks removing, relocating or accidentally killing the queen bee.

Similarly, in order to safely harvest the honey, an apiarist must remove the frames from the vicinity of the bees as they will defend the hive and try to move their honey back to the hive. Once removed, the full frames need to be relocated to a secure location distanced from the bees as they may travel long distances, e.g. 1 km or more, if they can scent their honey. The full frames also need to be stored securely, as bees will try to gain access to storage facilities and storage containers if they smell their honey.

Prior art honey extraction apparatus is known, such as AU 2020202354 to Mitchell, which teaches apparatus for extracting honey from honeycomb having a container and a holding arrangement within the container for holding honeycomb is a horizontal plane. Similarly, CN 211793743 to the Sichuan Vocational College of Information Technology describes a portable electric honey extractor which holds honeycomb frames inside a can and spins them with an electric motor to extract honey via centrifugal force. However, none of these prior art honey extractors facilitates the removal, transport and storage of honeycomb frames during hive inspection and/or honey collection, being only devised for honey extraction from honeycomb either under the influence of gravity after pressing, or via the artificial application of centrifugal force, potentially damaging the frames.

The current invention was conceived with the goal in mind of ameliorating the risks associated with inspecting a beehive, as well as removing, transporting and storing honeycomb frames from a beehive.

### SUMMARY OF THE INVENTION

According to an aspect of the invention there is provided a beehive frame transport cart comprising:
a support frame supporting a wheeled reservoir container which defines a honey reservoir with a tap located at a bottom thereof;
a plurality of open-bottomed frame containers each configured sealingly to stack on the reservoir container and/or each other, each frame container defining an internal upper peripheral ledge for receiving ends of beehive frames to suspend a plurality of said frames in a substantially vertical and side-by-side manner within said frame container;
a plurality of foraminous queen excluder plates each insertable at a bottom of a stacked frame container; and
a lid configured to seal an upper stacked frame container, or to engage with a bottom of a frame container to form a drip tray, as required, wherein a plurality of beehive frames is receivable, transportable and storable within the cart.

The skilled addressee is to appreciate that, in the art of beekeeping, a queen excluder is a selective barrier configured to allow worker bees, but not the larger queens and drones, to traverse the barrier. Accordingly, the foraminous queen excluder plates typically define foramina shaped and dimensioned to function as a queen excluder.

In an embodiment, the wheeled reservoir container defines an internal upper peripheral ledge for receiving ends of beehive frames to suspend a plurality of said frames in a substantially vertical and side-by-side manner within said reservoir container.

In an embodiment, the support frame defines a handle to facilitate ease of pushing or pulling said cart, said handle configured so that a resultant moment of a weight of the container(s) about wheels of the wheeled reservoir is easily offset by a counteracting force operatively applied along a length of the handle.

In an embodiment, the handle comprises a telescoping handle whereby a length and/or height thereof is adjustable.

In an embodiment, the reservoir container defines a sloped floor which is configured to direct honey in said reservoir towards the tap.

In an embodiment, the sloped floor defines a plurality of striations, ridges and/or grooves configured to direct honey in the reservoir towards the tap under the influence of gravity.

In an embodiment, the tap includes a filter configured to sift particulate material from honey.

In an embodiment, the reservoir container and/or the frame container(s) include suitable fasteners to facilitate stacking said containers in a sealing manner.

Typically, the fastener comprises an over-centre latch.

In an embodiment, the reservoir container and/or the frame container(s) include deployable handles to facilitate handling thereof.

In an embodiment, the reservoir and frame containers and the lid comprise similar cross-sectional profiles in order to complementarily engage when stacked to form a unitary cart.

In an embodiment, the lid defines ventilation apertures so that the cart is useable as a portable swarm collector.

In an embodiment, the reservoir container and/or the frame container(s) includes a seal to allow airtight and/or fluid tight sealing between stacked containers and/or the lid.

In an embodiment, the cart includes a tool tray configured to be complementarily stacked with the reservoir and frame containers, said tool tray configured to store beekeeping tools.

In an embodiment, the reservoir and/or frame containers are manufactured from an insulating material in order to regulate an internal temperature of said containers.

In an embodiment, the cart includes a removable cover which is placeable about the reservoir and/or frame containers in order to regulate an internal temperature of said containers.

In an embodiment, the reservoir and frame containers and the lid are manufactured from food-grade polymers.

In an embodiment, the reservoir and frame containers and/or the lid are manufactured from a transparent or translucent polymer to facilitate visual inspection of an interior of said containers.

Alternatively, the reservoir and frame containers and/or the lid are manufactured from an opaque material to minimize light exposure to honey and/or honeycomb within the container(s).

### BRIEF DESCRIPTION OF THE DRAWINGS

The description will be made with reference to the accompanying drawings in which:

FIG. 1 perspective-view is a diagrammatic representation of one possible embodiment of a beehive frame transport cart, in accordance with aspects of the present invention;

FIGS. 2a to 2d show diagrammatic side, front and bottom view representations of the beehive frame transport cart of FIG. 1;

FIG. 3 is diagrammatic exploded perspective-view representation of the beehive frame transport cart of FIG. 1;

FIGS. 4a to 4c show diagrammatic perspective and bottom view representations of a frame container of the beehive frame transport cart of FIG. 1; and

FIGS. 5a to 5c show diagrammatic perspective and side-sectional representations of a reservoir container of the beehive frame transport cart of FIG. 1.

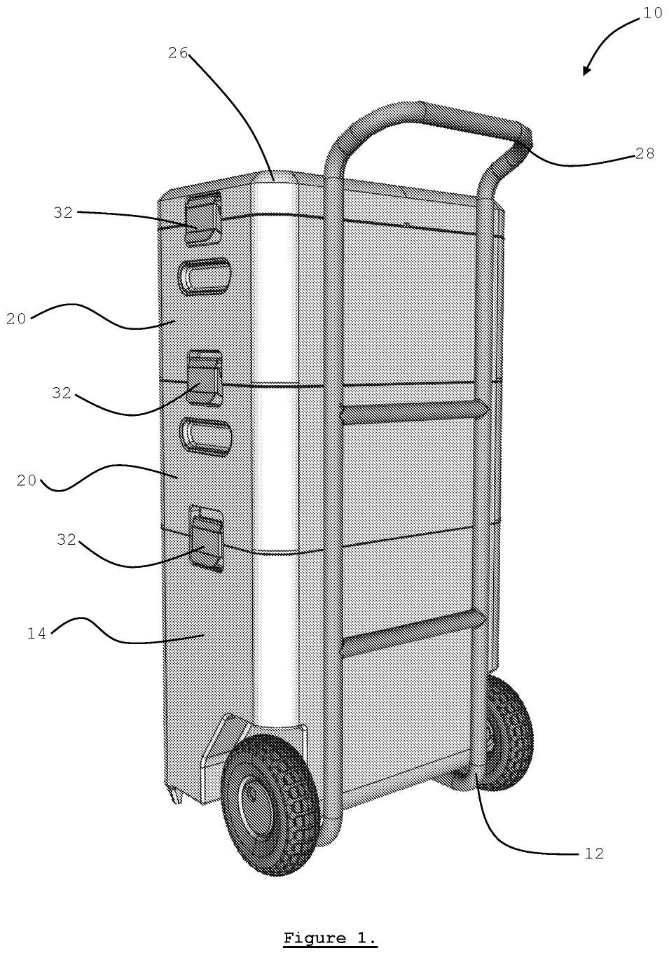

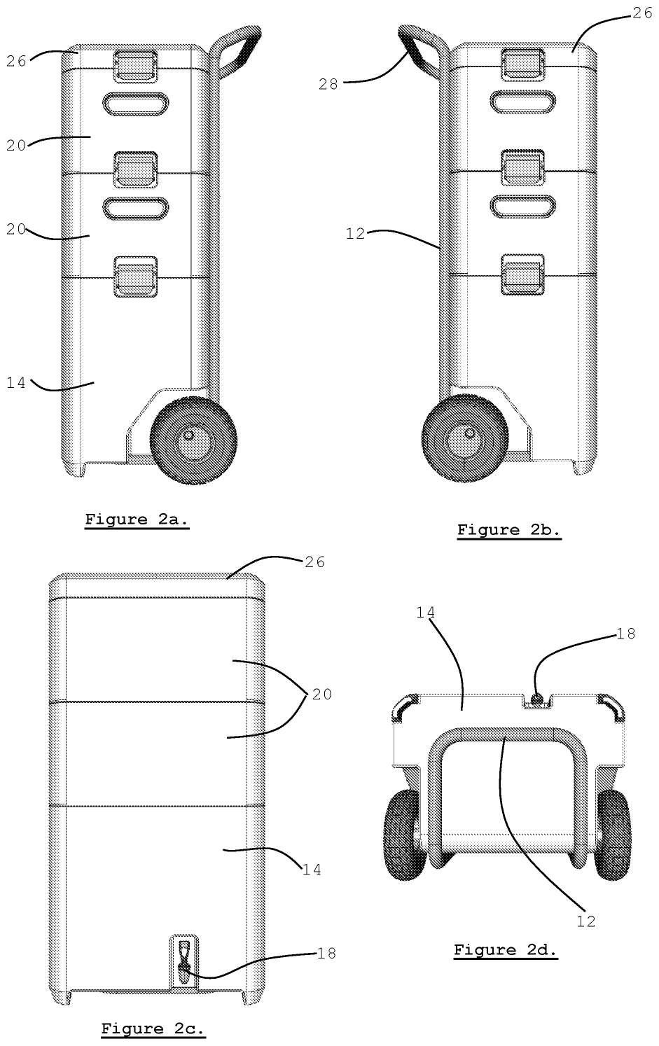

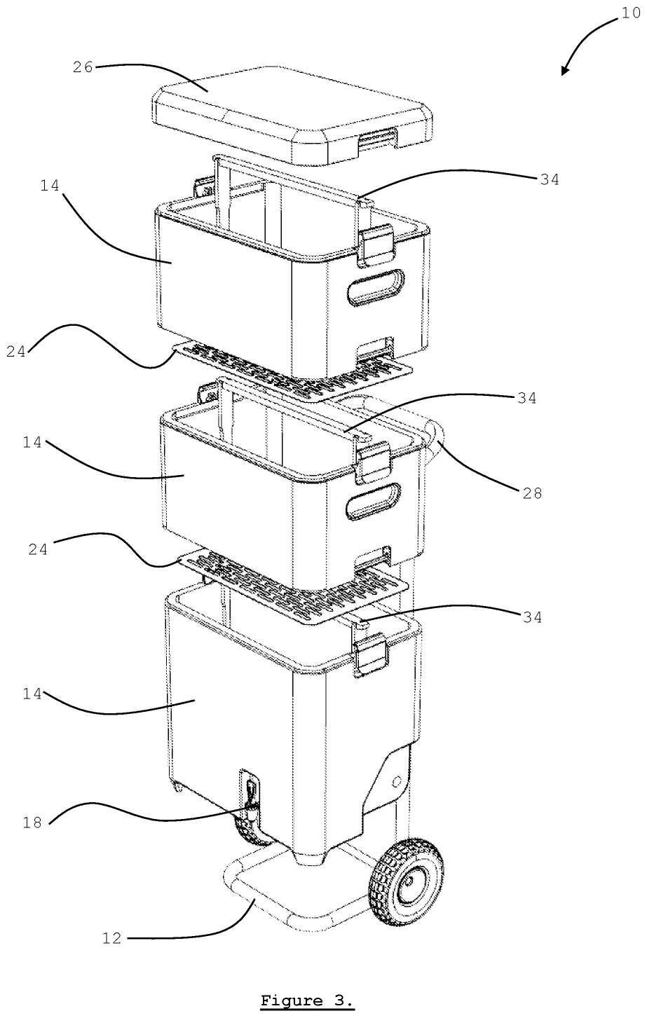

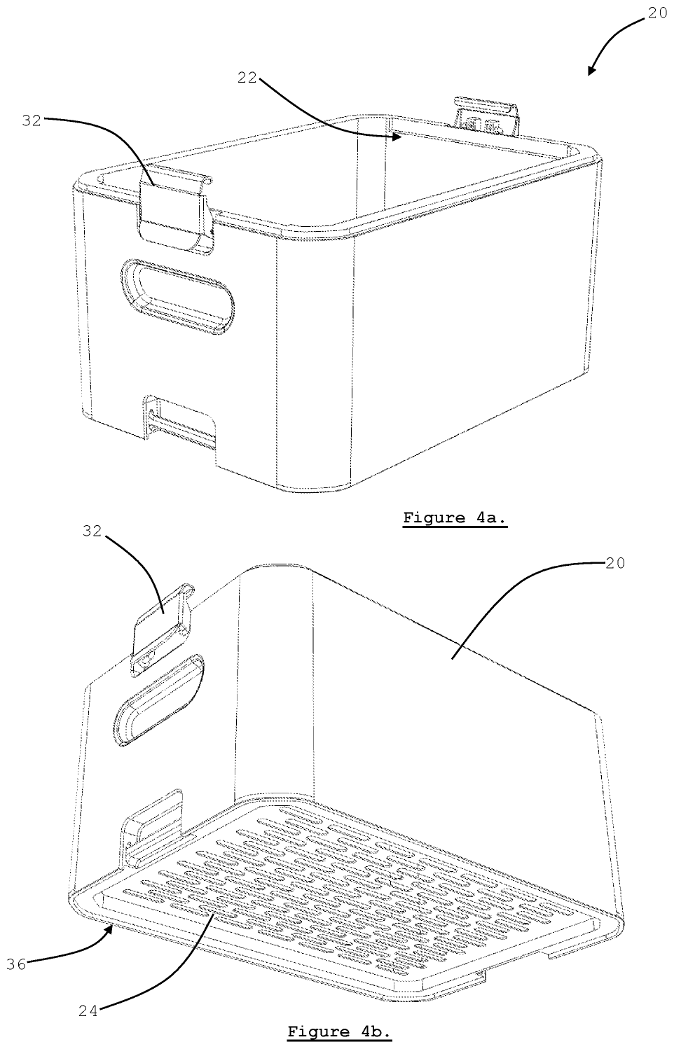

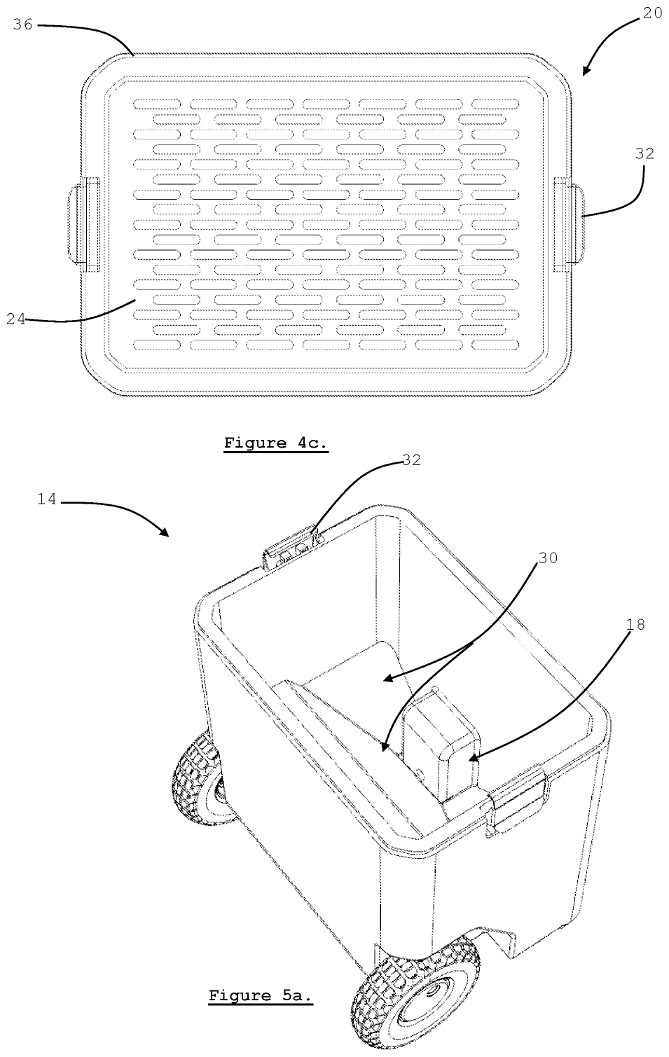

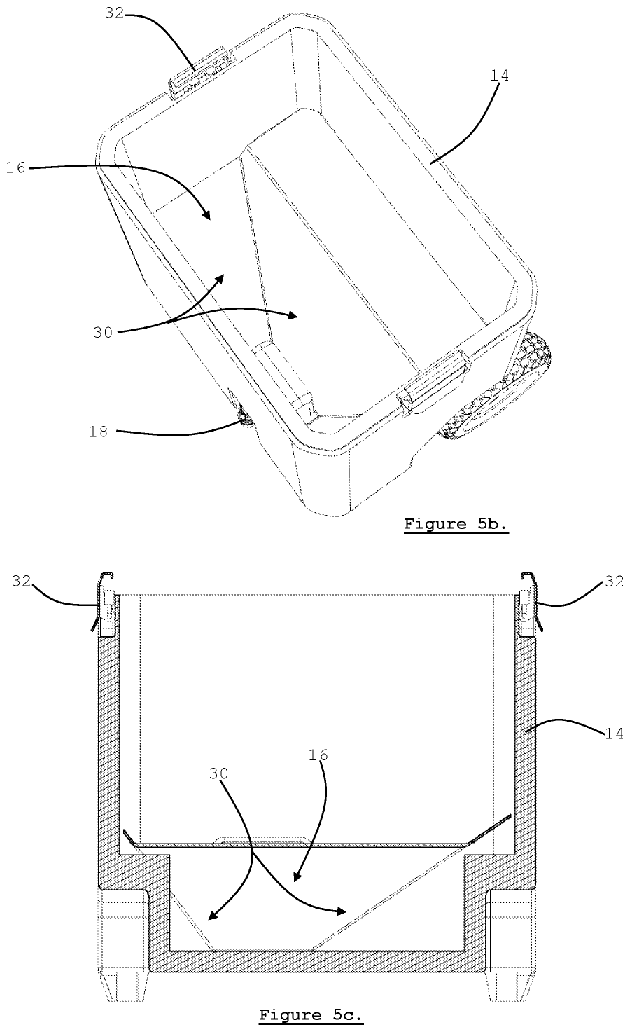

### DETAILED DESCRIPTION OF EMBODIMENTS

Further features of the present invention are more fully described in the following description of several non-limiting embodiments thereof. This description is included solely for the purposes of exemplifying the present invention to the skilled addressee. It should not be understood as a restriction on the broad summary, disclosure or description of the invention as set out above.

In the figures, incorporated to illustrate features of the example embodiment or embodiments, like reference numerals are used to identify like parts throughout. Additionally, features, mechanisms and aspects well-known and understood in the art will not be described in detail, as such features, mechanisms and aspects will be within the understanding of the skilled addressee.

With reference now to the accompanying figures, there is shown one possible embodiment of a beehive frame transport cart 10 in accordance with aspects of the present invention. Such a cart 10 finds particular application in an apiarian or beekeeping environment when inspecting a hive, or harvesting honey from honeycomb on beehive frames. Broadly, the cart 10 comprises a support frame 12 with wheeled reservoir container 14, a plurality of frame containers 20, and a lid 26.

More specifically, the beehive frame transport cart 10 comprises a support frame 12 which supports a wheeled reservoir container 14 which defines a honey reservoir 16 with a tap 18 located at a bottom thereof. Cart 10 also includes a plurality of open-bottomed frame containers 20, each of which is configured sealingly to stack on the reservoir container 14 and/or each other, to form a unitary cart. Each frame container 20 defines an internal upper peripheral ledge 22 for receiving ends of beehive frames to suspend a plurality of said frames in a substantially vertical and side-by-side manner within said frame container 20. Importantly, each frame container 20 is configured to receive and suspend beehive frames therein so that honey is able to drip under the influence of gravity towards the honey reservoir 16.

Cart 10 also includes a plurality of foraminous queen excluder plates 24 which are each insertable at a bottom of a stacked frame container 20, as well as a lid 26 which is configured to seal an upper stacked frame container 20, or to engage with a bottom of a frame container 20 to form a drip tray, as required. In this manner, a plurality of beehive frames is receivable, transportable and storable within the cart 10. Importantly, the queen excluder plates 24 that are stackable as part of the containers 14 and 20 allow the cart to store frames during hive inspection, as well as protecting the queen bee during frame removal and transport.

The skilled addressee is to appreciate that, in the art of beekeeping, a queen excluder is a selective barrier configured to allow worker bees, but not the larger queens and drones, to traverse the barrier. Accordingly, the foraminous queen excluder plates 24 typically define foramina shaped and dimensioned to function as a queen excluder.

In one embodiment, the wheeled reservoir container 14 also defines an internal upper peripheral ledge 26 for receiving ends of beehive frames to suspend a plurality of said frames in a substantially vertical and side-by-side manner within said reservoir container. In such an embodiment, the wheeled reservoir container 14 is generally deeper when compared to the open-bottomed frame containers 20 to allow space for honeycomb frames and the honey reservoir 16.

In one embodiment, the support frame 12 defines a handle 28 in order to facilitate ease of pushing or pulling said cart 10. The handle 28 may be telescoping to allow a length and/or height thereof to be adjustable and is typically configured so that a resultant moment of a weight of the container(s) 14 and 20 about wheels of the wheeled reservoir 14 is easily offset by a counteracting force operatively applied along a length of the handle.

In an embodiment, the reservoir container 14 defines a sloped floor 30 which is configured to direct honey in the reservoir 16 towards the tap 18. The sloped floor 20 may also define a plurality of striations, ridges and/or grooves (not shown) which are configured to direct honey in the reservoir 16 towards the tap 18 under the influence of gravity. In an embodiment, the tap 18 may include a filter configured to sift particulate material from honey. The skilled addressee is to appreciate that the tap 18 may take various forms, such as a stoppable aperture, a faucet-like tap, etc.

In one embodiment, the reservoir container 14 and/or the frame container(s) 20 include suitable fasteners 32 to facilitate stacking said containers in a sealing manner. Typically, these fasteners 32 comprises an over-centre latch or toggle, but variations hereon are possible and expected. In an embodiment, the reservoir container 14 and/or the frame container(s) 20 also include deployable handles 34 in order to facilitate handling thereof.

Preferably, the reservoir and frame containers 14 and 20 and the lid 26 typically comprise similar cross-sectional profiles in order to complementarily engage when stacked to form a unitary cart. In an embodiment, the lid 26 defines ventilation apertures so that the cart 10 is useable as a portable swarm collector. The lid 26 is generally configured to seal either the reservoir or frame containers 14 or 20, as required, and selectively to form a drip tray for a frame container 20, as required. For example, the lid 26 is generally interchangeable between containers 14 and 20 and can also be placed onto a bottom of a frame container 20 in order to function as a drip tray.

In one embodiment, the reservoir container 14 and/or the frame container(s) 20 includes a seal 36 to allow airtight and/or fluid tight sealing between stacked containers and/or the lid. In an embodiment, the cart 10 may also include a tool tray (not shown) which is configured to be complementarily stacked with the reservoir and frame containers 14 and 20, said tool tray configured to store beekeeping tools.

In an embodiment, the reservoir and/or frame containers 14 and 20 are manufactured from an insulating material in order to regulate an internal temperature of said containers. In an embodiment, the cart 10 includes a removable cover (not shown) which is placeable about the reservoir and/or frame containers 14 and 20 in order to regulate an internal temperature of said containers.

In an embodiment, the reservoir and frame containers 14 and 20 and the lid 26 are generally manufactured from food-grade polymers. In an embodiment, the reservoir and frame containers and/or the lid may also be manufactured from a transparent or translucent polymer to facilitate visual inspection of an interior of said containers, e.g. include at least a part translucent or transparent section to allow inspection of, for example, a level of honey within the honey reservoir 16, or the like. Alternatively, an opaque material may be used which may facilitate in long-term storage of honey, i.e. minimize exposure to outside light, or the like.

In the manner described, by stacking frame containers 20 on top of each other with the reservoir container 14 at the bottom with said containers supported on the frame 12, facilitates storage and transport of beehive frames.

Applicant believes it particularly advantageous that the present invention provides for a cart 10 which can be used for inspection of hives and/or storage purposes of honeycomb frames. The various containers may also be separated for use in alternative configurations to address the alternative stages of the honey harvesting process. Additionally, cart 10 ameliorates a risk of carrying heavy frames and allows for the easy removal and sealing of honeycomb from a hive. In addition, cart 10 allows collection and storage of honey in a sealed environment preventing bee death and robbing.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth. In the example embodiments, well-known processes, well-known device structures, and well-known technologies are not described in detail, as such will be readily understood by the skilled addressee.

The use of the terms “a”, “an”, “said”, “the”, and/or similar referents in the context of describing various embodiments (especially in the context of the claimed subject matter) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to, ”) unless otherwise noted. As used herein, the term “and/or” includes any and all combinations of one or more of the associated listed items. No language in the specification should be construed as indicating any non-claimed subject matter as essential to the practice of the claimed subject matter.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

It is to be appreciated that reference to “one example” or “an example” of the invention, or similar exemplary language (e.g., “such as”) herein, is not made in an exclusive sense. Accordingly, one example may exemplify certain aspects of the invention, whilst other aspects are exemplified in a different example. These examples are intended to assist the skilled person in performing the invention and are not intended to limit the overall scope of the invention in any way unless the context clearly indicates otherwise. Variations (e.g. modifications and/or enhancements) of one or more embodiments described herein might become apparent to those of ordinary skill in the art upon reading this application. The inventor(s) expects skilled artisans to employ variations as appropriate, and the inventor(s) intends for the claimed subject matter to be practiced other than as specifically described herein.

1. A beehive frame transport cart comprising:
a support frame supporting a wheeled reservoir container which defines a honey reservoir with a tap located at a bottom thereof;
a plurality of open-bottomed frame containers each configured sealingly to stack on the reservoir container and/or each other, each frame container defining an internal upper peripheral ledge for receiving ends of beehive frames to suspend a plurality of said frames in a substantially vertical and side-by-side manner within said frame container;
a plurality of foraminous queen excluder plates each insertable at a bottom of a stacked frame container; and
a lid configured to seal an upper stacked frame container, or to engage with a bottom of a frame container to form a drip tray, as required, wherein a plurality of beehive frames is receivable, transportable and storable within the cart.

2. The cart of claim 1, wherein the foraminous queen excluder plates define foramina shaped and dimensioned to function as a queen excluder.

3. The cart of claim 1, wherein the wheeled reservoir container defines an internal upper peripheral ledge for receiving ends of beehive frames to suspend a plurality of said frames in a substantially vertical and side-by-side manner within said reservoir container.

4. The cart of claim 1, wherein the support frame defines a handle to facilitate ease of pushing or pulling said cart, said handle configured so that a resultant moment of a weight of the container(s) about wheels of the wheeled reservoir is easily offset by a counteracting force operatively applied along a length of the handle.

5. The cart of claim 4, wherein the handle comprises a telescoping handle whereby a length and/or height thereof is adjustable.

6. The cart of claim 1, wherein the reservoir container defines a sloped floor which is configured to direct honey in said reservoir towards the tap.

7. The cart of claim 6, wherein the sloped floor defines a plurality of striations, ridges and/or grooves configured to direct honey in the reservoir towards the tap under the influence of gravity.

8. The cart of claim 1, wherein the tap includes a filter configured to sift particulate material from honey.

9. The cart of claim 1, wherein the reservoir container and/or the frame container(s) include suitable fasteners to facilitate stacking said containers in a sealing manner.

10. The cart of claim 9, wherein the fastener comprises an over-centre latch or toggle.

11. The cart of claim 1, wherein the reservoir container and/or the frame container(s) include deployable handles to facilitate handling thereof.

12. The cart of claim 1, wherein the reservoir and frame containers and the lid comprise similar cross-sectional profiles in order to complementarily engage when stacked to form a unitary cart.

13. The cart of claim 1, wherein the lid defines ventilation apertures so that the cart is useable as a portable swarm collector.

14. The cart of claim 1, wherein the reservoir container and/or the frame container(s) includes a seal to allow airtight and/or fluid tight sealing between stacked containers and/or the lid.

15. The cart of claim 1, which includes a tool tray configured to be complementarily stacked with the reservoir and frame containers, said tool tray configured to store beekeeping tools.

16. The cart of any claim 1, wherein the reservoir and/or frame containers are manufactured from an insulating material in order to regulate an internal temperature of said containers.

17. The cart of claim 1, which includes a removable cover which is placeable about the reservoir and/or frame containers in order to regulate an internal temperature of said containers.

18. The cart of claim 1, wherein the reservoir and frame containers and the lid are manufactured from food-grade polymers.

19. The cart of claim 1, wherein the reservoir and frame containers and/or the lid are manufactured from a transparent or translucent polymer to facilitate visual inspection of an interior of said containers.

20. The cart of claim 1, wherein the reservoir and frame containers and/or the lid are manufactured from an opaque material to minimize light exposure to honey and/or honeycomb within the container(s).
